(19) United States
(12) Patent Application Publication
(10) Pub. No.: US 2005/0193092 A1
(43) Pub. Date: Sep. 1, 2005

(54) Method and system for controlling an in-vehicle CD player

(75) Inventor: Stephen C. Habermas, Beverly Hills, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/741,250

(22) Filed: Dec. 19, 2003

(51) Int. Cl. G06F 15/16

(52) U.S. Cl. 709/219

(57) ABSTRACT

The present invention provides a method for controlling a compact disc player in a telematics equipped mobile vehicle that includes receiving CD data, from at least one compact disc, and analog input at the telematics unit. The method further includes producing a metadata file based on the received CD data, producing a speech recognition grammar file based on the metadata file, producing a dialog command based on the received analog input, and controlling the compact disc player in the telematics equipped mobile vehicle responsive to a control command. The control command is based on the speech recognition grammar file and the dialog command. The metadata is selected from one or more members of a group including: disc title, artist name, song title, disc number, and track number.

### FIELD OF THE INVENTION

In general, the invention relates to controlling a compact disc player. More specifically, the invention relates to a method and system for controlling a compact disc player in a telematics equipped mobile vehicle.

### BACKGROUND OF THE INVENTION

The opportunity to personalize features in a mobile vehicle is ever increasing as the automobile is being transformed into a communications and entertainment platform as well as a transportation platform. Many vehicles now have hundreds of personalization settings such as seat and mirror positions, door lock/unlock behavior, radio station present selections, climate controls, custom button configurations and theft alarm settings. As more and more new vehicles will have some level of telematics service, most vehicles will support customization or personalization of wireless vehicle communication, networking, maintenance and diagnostic services.

Controller systems may be configured or updated in a manner similar to software updates. Even liquid crystal (LCD) displays on the dashboard may be reconfigurable with changes on which data is on the center screen and which is relegated to side panels. For example, it is possible to rearrange dashboard displays for the speedometer, global positioning system (GPS), map navigation, cell phone, two-way radio, maps, radio presets, and mirror and seating settings.

Recently, telematics units (MCU's) have been produced with integrated entertainment components, such as, for example radio receivers and compact disc (CD) players. Alternatively, telematics units have been produced allowing existing entertainment components to be interfaced with the telematics units. Because the entertainment components are integrated/interfaced with the telematics unit, the entertainment components functionality can be enhanced. It is desirable to have an improved method and system for controlling entertainment components.

### SUMMARY OF THE INVENTION

One aspect of the invention includes a method for controlling a compact disc player in a telematics equipped mobile vehicle. The method includes receiving CD data from at least one compact disc and analog input at the telematics unit, producing a metadata file based on the received CD data, and producing a speech recognition grammar file based on the metadata file. The method additionally includes producing a dialog command based on the received analog input and controlling the compact disc player in the telematics equipped mobile vehicle responsive to a control command. The control command is based on the speech recognition grammar file and the dialog command.

In accordance with another aspect of the invention, a computer readable medium storing a computer program includes: computer readable code for receiving CD data and analog input at the telematics unit, the CD data received from at least one compact disc; computer readable code for producing a metadata file based on the received CD data; computer readable code for producing a speech recognition grammar file based on the metadata file; computer readable code for producing a dialog command based on received analog input; and computer readable code for controlling the compact disc player in the telematics equipped mobile vehicle responsive to a control command, the control command based on the speech recognition grammar file and the dialog command.

In accordance with yet another aspect of the invention, a system for controlling a compact disc player in a telematics equipped mobile vehicle is provided. The system includes means for receiving CD data at the telematics unit from at least one compact disc. The system additionally includes means for producing a metadata file based on the received CD data. Means for producing a speech recognition grammar file based on the metadata file is provided. Means for receiving a dialog command and means for controlling the compact disc player in the telematics equipped mobile vehicle based on the dialog command are also provided.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates one embodiment of an operating environment in accordance with the current invention;

FIG. 2 illustrates another embodiment of an operating environment in accordance with the current invention;

FIG. 3 is a block diagram illustrating a system for controlling an in-vehicle CD player in accordance with one embodiment of the present invention;

FIG. 4 is a block diagram illustrating a system for controlling an in-vehicle CD player in accordance with another embodiment of the present invention;

FIG. 5 is a block diagram illustrating a system for controlling an in-vehicle CD player in accordance with yet another embodiment of the present invention;

FIG. 6 is a flow diagram of an embodiment of a method of controlling an in-vehicle CD player, in accordance with the current invention;

FIG. 7 is a flow diagram of another embodiment of a method of controlling an in-vehicle CD player, in accordance with the current invention;

FIG. 8 is a flow diagram of yet another embodiment of a method of controlling an in-vehicle CD player, in accordance with the current invention; and

FIG. 9 is a flow diagram of another embodiment of a method of controlling an in-vehicle CD player, in accordance with the current invention.

### DETAILED DESCRIPTION OF THE PRESENTLY PREFERRED EMBODIMENTS

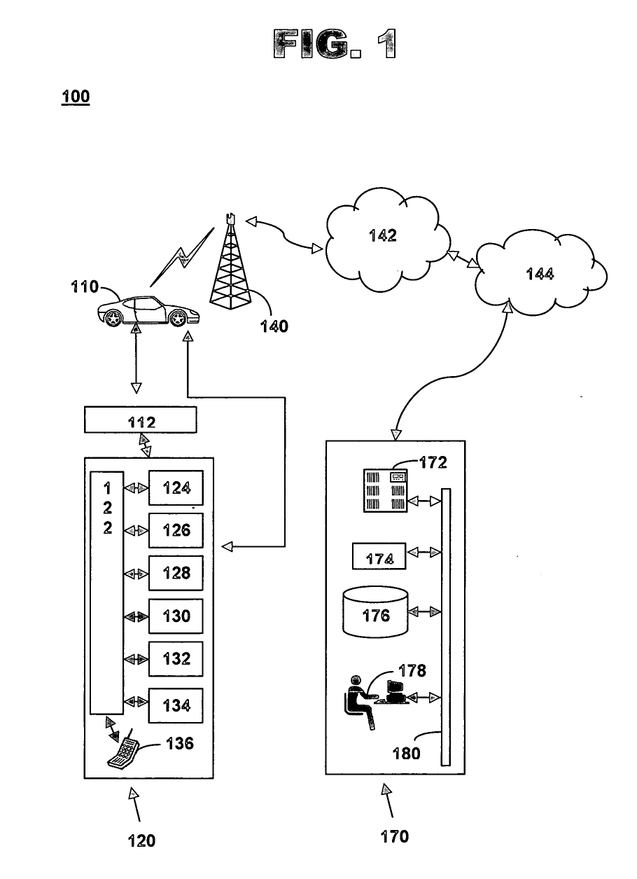

FIG. 1 is a block diagram illustrating an example of an operating environment that is in accordance with the present invention. FIG. 1 details an embodiment of a system for operating a wireless communication service in a mobile vehicle, and may be referred to as a mobile vehicle communication system (MVCS) 100. Mobile vehicle communication system (MVCS) 100 includes a mobile vehicle 110, a vehicle communication bus 112, a telematics unit 120, one or more wireless carrier systems 140, one or more communication networks 142, one or more land networks 144, and one or more call centers 170. In one embodiment, mobile vehicle 110 is implemented as a mobile vehicle equipped with suitable hardware and software for transmitting and receiving voice and data communications. MVCS 100 may include additional components not relevant to the present discussion.

Telematics unit 120 includes a digital signal processor (DSP) 122 connected to a wireless modem 124, a global positioning system (GPS) unit 126, an in-vehicle memory 128, a microphone 130, one or more speakers 132, an embedded or in-vehicle compact disc (CD) player 134, and, an embedded or in-vehicle mobile phone 136. In one embodiment, DSP 122 is implemented as a microcontroller, controller, host processor, or vehicle communications processor. In another embodiment, DSP 122 is implemented as a processor working in conjunction with a central processing unit (CPU) performing the function of a general purpose processor. GPS unit 126 provides longitude and latitude coordinates of the vehicle. In-vehicle mobile phone 134 is a cellular-type phone, such as, for example an analog, digital, dual-mode, dual-band, multi-mode or multi-band cellular phone. In one embodiment, in-vehicle CD player 134 is implemented as a conventional in-vehicle CD player or portable CD player interfaced with digital signal processor (DSP) 122. In another embodiment, in-vehicle CD player 134 is implemented as an integrated entertainment component, such as, for example an embedded CD player.

DSP 122 executes various computer programs that interact with electronic and mechanical systems within mobile vehicle 110. DSP 122 controls communications between telematics unit 120, wireless carrier system 140, and call center 170. In one embodiment, a speech-recognition application is installed in DSP 122 that can translate human speech input through microphone 130 to digital signals. DSP 122 generates and accepts digital signals transmitted between telematics unit 120 and a vehicle communication bus 112 that is connected to various electronic modules in the vehicle. In one embodiment, these digital signals activate the programming mode and operation modes, as well as provide for data transfers. In this embodiment, signals from DSP 122 are translated into analog voice messages and sent out through speaker 132.

Mobile vehicle 110, via a vehicle communication bus 112, sends signals to various units of equipment and systems within mobile vehicle 110 to perform various functions such as unlocking a door, opening the trunk, setting personal comfort settings, and calling from telematics unit 120. In facilitating interactions among the various communication and electronic modules, vehicle communication bus 112 utilizes bus interfaces such as controller-area network (CAN), International Organization for Standardization (ISO) Standard 9141, J1850, ISO Standard 11898 for high-speed applications, and ISO Standard 11519 for lower speed applications.

Mobile vehicle 110, via telematics unit 120, sends and receives radio transmissions from wireless carrier system 140. Wireless carrier system 140 is implemented as any suitable system for transmitting a signal from mobile vehicle 110 to communication network 142.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to mobile vehicle 110 and land network 144.

Land network 144 connects communication network 142 to call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connects wireless carrier system 140 to call center 170.

Call center 170 is a location where many calls are received and serviced at the same time, or where many calls are sent at the same time. In one embodiment, the call center is a telematics call center, prescribing communications to and from telematics unit 120 in mobile vehicle 110. In an example, the call center is a voice call center, providing verbal communications between an advisor in the call center and a subscriber in a mobile vehicle. In another example, the call center contains each of these functions.

Call center 170 contains one or more voice and data switches 172, one or more communication services managers 174, one or more communication services databases 176, one or more communication services advisors 178, and one or more networks 180.

Switch 172 of call center 170 connects to land network 144. Switch 172 transmits voice or data transmissions from call center 170, and receives voice or data transmissions from telematics unit 120 in mobile vehicle 110 through wireless carrier system 140, communication network 142, and land network 144. Switch 172 receives data transmissions from or sends data transmissions to one or more communication services managers 174 via one or more networks 180.

Communication services manager 174 is any suitable hardware and software capable of providing requested communication services to telematics unit 120 in mobile vehicle 110. Communication services manager 174 sends to or receives from one or more communication services databases 176 data transmissions via networks 180. Communication services manager 174 sends to or receives from one or more communication services advisors 178 data transmissions via networks 180. Communication services database 176 sends to or receives from communication services advisor 178 data transmissions via networks 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, communications assistance, and server-side processing. Communication services manager 174 receives server-side processing requests for a variety of services from the user via land network 144. Communication services manager 174 transmits server-side processed data to telematics unit 120 in mobile vehicle 110 through wireless carrier system 140, communication network 142, land network 144, voice and data switch 172, and networks 180. Communication services manager 174 stores or retrieves data and information from communication services database 176.

Mobile vehicle 110 initiates server-side processing requests to call center 170 by sending a voice or digital-signal command to telematics unit 120 which in turn, sends an instructional signal and a data signal through wireless modem 124 or through wireless carrier system 140. The instructional signal and data signal are routed through communication network 142 and land network 144, to call center 170.

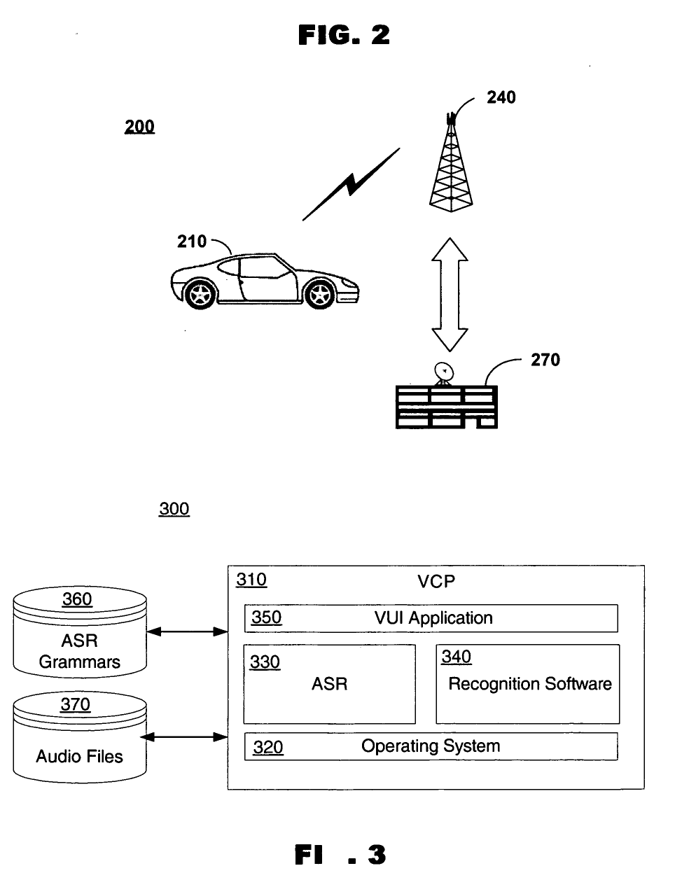

FIG. 2 illustrates another embodiment of an operating environment, in accordance with the current invention. Mobile vehicle communication system (MVCS) 200 includes one or more mobile vehicles 210, one or more wireless carrier systems 240, and one or more call centers 270. MVCS 200 may include additional components not relevant to the present discussion.

In one embodiment of the present invention, a driver, subscriber or user of a mobile vehicle utilizes an in-vehicle telematics unit to transmit data to call center 270 for server-side processing. In this embodiment, the in-vehicle telematics unit sends data received from an in-vehicle CD player (not shown) to call center 270 for server-side processing via one or more wireless carrier systems 240. Call center 270 conducts the server-side processing of the data and returns a processed data to mobile vehicle 210.

In another embodiment, the in-vehicle telematics unit sends data received from an in-vehicle CD player (not shown) and a dialog command to call center 270 for server-side processing via one or more wireless carrier systems 240. In an example, the dialog command is an analog signal. In another example, the dialog command is a digital signal. In this embodiment, call center 270 conducts the server-side processing of the data and the dialog command and returns a control command to mobile vehicle 210.

FIG. 3 is a block diagram illustrating a system 300 for controlling an in-vehicle CD player. System 300 includes vehicle communication platform (VCP) 310, advanced speech recognition (ASR) grammars database 360, and audio files (e.g. WAV files) database 370. System 300 may include additional components not relevant to the present discussion.

Vehicle communication platform (VCP) 310, also referred to as a telematics unit, includes an operating system 320, advanced speech recognition (ASR) software 330, compact disc (CD) recognition software 340, and a voice user interface (VUI) 350Operating system 320 operates within VCP 310. Voice user interface (VUI) 350 is a software framework that allows interaction between a client and an application operating within VCP 310. Advanced speech recognition (ASR) software 330 and CD recognition software 340 are applications that operate within VCP 310.

ASR grammars database 360 is a vehicle-side database that receives and stores data from as well as locates and sends requested data to VUI 350 and related applications operating within VCP 310, such as, for example advanced speech recognition (ASR) software 330. In one embodiment, ASR grammars database 360 stores user profile information, such as, for example client speech-imprint data as well as other relevant information. ASR grammars database 360 may be implemented as any suitable database application.

Audio files database 370 is a vehicle-side database that receives and stores data from as well as locates and sends requested data to VUI 350 and related applications operating within VCP 310. In one embodiment, audio files database 370 stores vehicle-side audio files, such as, for example vehicle side speech-imprint data for use in interaction with the client, as well as other relevant information. Audio files database 370 may be implemented as any suitable database application.

Advanced speech recognition (ASR) software 330 is an application that interacts with a client via VUI 350. ASR software 330 receives an analog input from a user via VUI 350, and produces a dialog command based on the analog input. In one embodiment, ASR software 330 receives the analog input from VUI 350 and requests grammar files from ASR grammars database 360. In an example, ASR software 330 is implemented as a dynamic grammar control mechanism. ASR software 330 compares the received analog input to the grammar files received from ASR grammars database 360 to determine whether the received analog input matches grammar files stored within ASR grammars database 360.

In one embodiment, upon determination of a match to the grammar files received from ASR grammars database 360, a dialog command is produced. The dialog command is then sent to VUI 350 for execution. In this embodiment, if the received analog input does not match the grammar files received from ASR grammars database 360, ASR software 330 will enter a learning mode and interact with the user via VUI 350 in an attempt to determine (i.e. to learn) what the user is attempting to communicate to system 300. In an example, ASR software 330 enters a learning mode and interacts with the user via VUI 350 in an attempt to determine a new command the user has utilized. In another embodiment, ASR software 330 enters a learning mode and interacts with the user via VUI 350 in an attempt to determine a new pronunciation pattern of existing grammar files within ASR grammars database 360.

CD recognition software 340 is an application that interacts with a CD player via VUI 350. CD recognition software 340 receives CD data from the CD player (not shown) via VUI 350 and produces a metadata file based on the CD data. In one embodiment, VUI 350 uses business application software to request and receive CD data, such as, for example table of contents data from the CD player. The received CD data is then sent to CD recognition software 340 for processing. CD recognition software 340 receives the CD data from VUI 350 and utilizes commercially available music recognition software to produce the metadata file. The metadata file includes CD information, such as, for example disc title, artist name, song title, disc number, and track number.

In operation and referring to FIGS. 1 and 3, voice user interface (VUI) 350 (located within DSP 122) receives an analog input from a user (through microphone 130) and receives CD data from the CD player 134. The analog input is sent to ASR software 330 and the CD data is sent to CD recognition software 340 for processing.

In an example, a user provides an analog input of “play song title (#2) of disc 3” and there are three or more compact discs in the CD player. In this example, VUI 350 sends the analog input to ASR software 330 for processing. Additionally, if the CD data from the CD player has not already been processed into metadata, the CD data is requested by VUI 350 and sent to CD recognition software 340 for processing upon reception. The metadata file is then sent to vehicle communication platform (VCP) 310 for processing into a CD speech recognition grammar file. In one embodiment, VCP 310 produces a CD speech recognition grammar file that is compatible with ASR software 330.

Upon completion of the processing of the user provided analog input by ASR software 330 (described above), a dialog command is produced. In one embodiment, the dialog command is sent to VCP 310 for further processing. VCP 310 produces a control command, such as, for example by comparing the dialog command to the CD speech recognition grammar file. The control command is then sent to CD player 134 for execution.

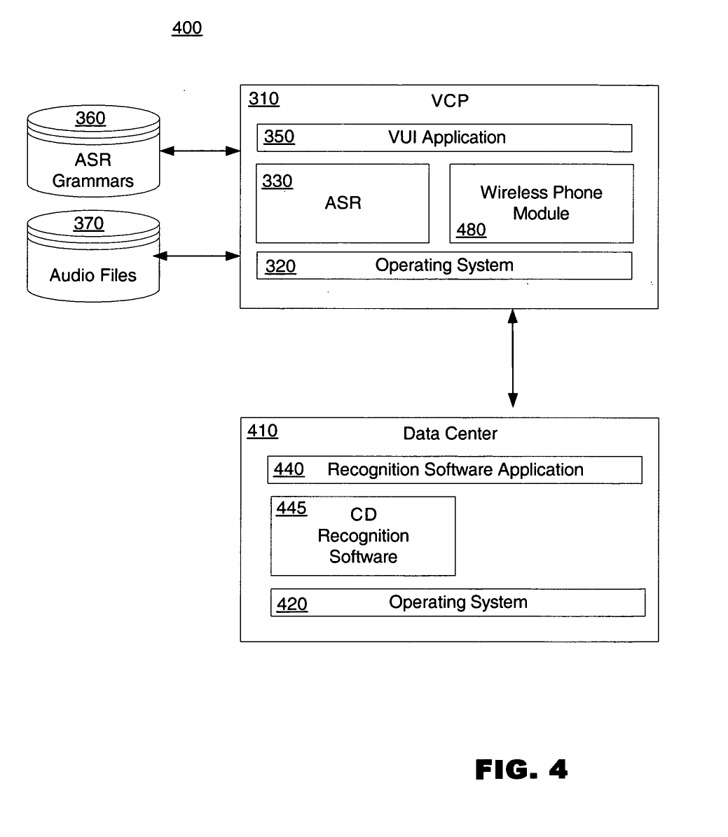

FIG. 4 is a block diagram illustrating another system 400 for controlling an in-vehicle CD player. System 400 includes vehicle communication platform (VCP) 310, advanced speech recognition (ASR) grammars database 360, audio files (e.g. .WAV files) database 370, and data center 410. Vehicle communication platform (VCP) 310 includes an operating system 320, an advanced speech recognition (ASR) software 330, a voice user interface (VUI) 350, and a wireless phone module 480. Like components from FIG. 3 perform in substantially the same way. System 400 may include additional components not relevant to the present discussion.

Data center 410, also referred to as an application server, includes an operating system 420, a recognition software application 440, and compact disc (CD) recognition software 445. Data center 410 facilitates operation of software applications operating within data center 410 as well as providing conduits into and out of data center 410. Data centers are known to those of ordinary skill in the art, and data centers may assume a variety of configurations. Operating system 420 operates within data center 410.

Recognition software application 440 is a software framework that allows interaction between modules (e.g. wireless phone module 480 discussed below) operating within voice user interface (VUI) 350 on vehicle communication platform (VCP) 310 and software operating within recognition software application 440. CD recognition software 445 operates within recognition software application 440.

CD recognition software 445 is an application that receives CD data from VUI 350 via wireless phone module 480 and recognition software application 440, and produces a metadata file based on the received CD data. In one embodiment, VUI 350 uses business application software to request and receive CD data, such as, for example table of contents data from the CD player. The received CD data is sent to CD recognition software 445 for processing. CD recognition software 445 receives the CD data from VUI 350 and utilizes commercially available music recognition software to produce the metadata file. The metadata file includes CD information, such as, for example disc title, artist name, song title, disc number, and track number.

The metadata file is sent to VUI 350 for further processing. In one embodiment and referring to FIGS. 1, 2, and 4, the metadata file is sent from CD recognition software 445 via software application 440 operating within call center (170, 270). The metadata file is sent to VUI 350 through wireless phone module 480 via wireless carrier system (140, 240).

In operation and referring to FIGS. 1, 2, and 4, voice user interface (VUI) 350 (located within DSP 122) receives an analog input from a user (through microphone 130) and receives CD data from the CD player 134. The analog input is sent to ASR software 330 for processing, and the CD data is sent to CD recognition software 445 via wireless module 480 and recognition software application 440 for processing. The CD data is sent from VUI 350, via wireless phone module 480, through wireless carrier system (140, 240). VUI 350 and wireless phone module 480 operate on DSP 122 of telematics unit 120 that is located within mobile vehicle (110, 210). The CD data is received at call center (170, 270) for processing by CD recognition software 445.

Upon completion of the processing of the CD data (described above), a metadata file is sent to VUI 350, via recognition software application 440, through wireless carrier system (140, 240). The metadata file is then sent to vehicle communication platform (VCP) 310 for processing into a CD speech recognition grammar file. In one embodiment, VCP 310 produces a CD speech recognition grammar file that is compatible with ASR software 330.

Upon completion of the processing of the user provided analog input by ASR software 330 (described above), a dialog command is produced. In one embodiment, the dialog command is sent to VCP 310 for further processing. VCP 310 produces a control command, such as, for example by comparing the dialog command to the CD speech recognition grammar file. The control command is then sent to (CD) player 134 for execution.

The above described embodiment allows for a portion of the processing to be completed by a server-side processor as well as a vehicle-side processor. In one embodiment, the above described embodiment allows the present invention to be utilized in pre-existing mobile vehicles that are not equipped with components to conduct requests and reception of CD data, but are equipped with advanced speech recognition (ASR) capabilities.

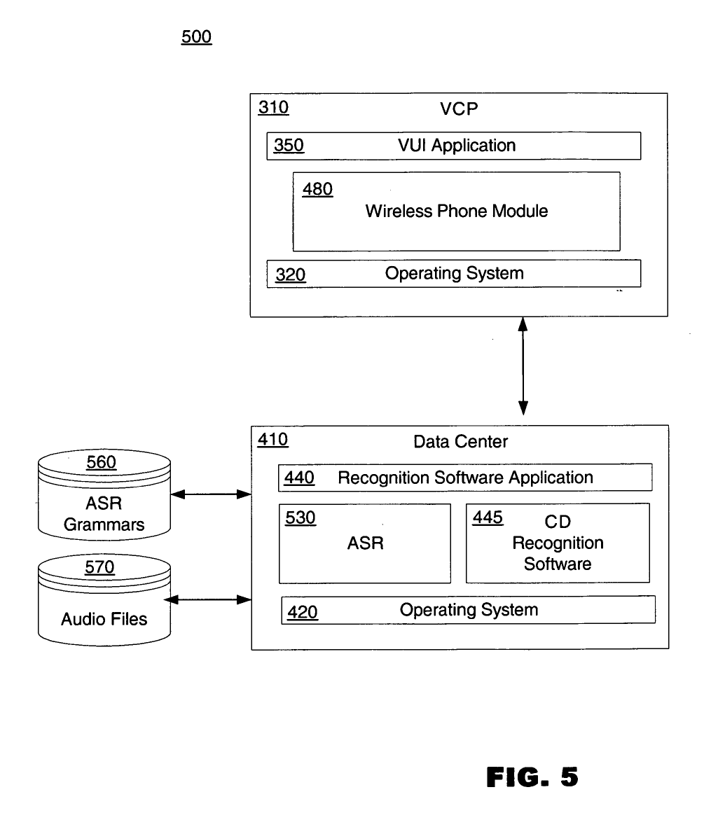

FIG. 5 is a block diagram illustrating another system 500 for controlling an in-vehicle CD player. System 500 includes vehicle communication platform (VCP) 310, data center 410, advanced speech recognition (ASR) grammars database 560, and audio files (e.g. .WAV files) database 570. System 500 may include additional components not relevant to the present discussion.

Vehicle communication platform (VCP) 310 includes an operating system 320, a voice user interface (VUI) 350, and a wireless phone module 480. Like components from FIGS. 3 and 4 perform in substantially the same way. Data center 410, also referred to as an application server, includes an operating system 420, a recognition software application 440, CD recognition software 445, and advanced speech recognition (ASR) software 530. Like components from FIG. 4 perform in substantially the same way. Advanced speech recognition (ASR) software 530 operates within recognition software application 440.

ASR grammars database 560 is a server-side database that receives and stores data from as well as locates and sends requested data to data center 410 and related applications operating within data center 410, such as, for example advanced speech recognition (ASR) software 530. In one embodiment, ASR grammars database 560 stores user profile information, such as, for example client speech-imprint data as well as other relevant information. ASR grammars database 560 may be implemented as any suitable database application.

Audio files database 570 is a server-side database that receives and stores data from as well as locates and sends requested data to data center 410 and related applications operating within data center 410. In one embodiment, audio files database 570 stores vehicle-side audio files, such as, for example vehicle speech-imprint data for use in interaction with the client, as well as other relevant information. Audio files database 570 may be implemented as any suitable database application.

Advanced speech recognition (ASR) software 530 is an application that interacts with a client via recognition software application 440, wireless phone module 480, and VUI 350. ASR software 530 receives an analog input from a user, and produces a dialog command based on the analog input. In one embodiment, ASR software 530 receives the analog input from VUI 350 via wireless phone module 480 and requests grammar files from ASR grammars database 560. In an example, ASR software 530 is implemented as a dynamic grammar control mechanism. ASR software 530 compares the received analog input to the grammar files received from ASR grammars database 560 to determine whether the received analog input matches grammar files stored within ASR grammars database 560.

In one embodiment, upon determination of a match to the grammar files received from ASR grammars database 560, a dialog command is produced. The dialog command is then sent to VUI 350 via wireless phone module 480 for execution. In this embodiment, if the received analog input does not match the grammar files received from ASR grammars database 560, ASR software 530 will enter a learning mode and interact with the user via VUI 350 via wireless phone module 480 in an attempt to determine (i.e. to learn) what the user is attempting to communicate to system 300.

In an example, ASR software 530 enters a learning mode and interacts with the user via VUI 350 via wireless phone module 480 in an attempt to determine a new command the user has utilized. In another embodiment, ASR software 530 enters a learning mode and interacts with the user via VUI 350 via wireless phone module 480 in an attempt to determine a new pronunciation pattern of existing grammar files within ASR grammars database 560.

In operation and referring to FIGS. 1, 2, and 5, voice user interface (VUI) 350 (located within DSP 122) receives an analog input from a user (through microphone 130) and receives CD data from the CD player 134. The analog input is sent to ASR software 530 and the CD data is sent to CD recognition software 445, via wireless module 480 and recognition software application 440, for processing. The CD data and analog input are sent from VUI 350, via wireless phone module 480, through wireless carrier system (140, 240). VUI 350 and wireless phone module 480 operate on DSP 122 of telematics unit 120 that is located within mobile vehicle (110, 210). The CD data and analog input are received at call center (170, 270) for processing by CD recognition software 445 and ASR software 530 respectively.

Upon completion of the processing of the CD data (described above), a metadata file is produced. The metadata file is then sent to data center 410 for processing into a CD speech recognition grammar file. In one embodiment, data center 410 produces a CD speech recognition grammar file that is compatible with ASR software 530.

Upon completion of the processing of the user provided analog input by ASR software 530 (described above), a dialog command is produced. In one embodiment, the dialog command is sent to data center 410 for further processing. Data center 410 produces a control command, such as, for example by comparing the dialog command to the CD speech recognition grammar file. The control command is then sent to VCP 310 via recognition software application 440, through wireless carrier system (140, 240). Once received at VCP 310 within mobile vehicle (110, 210), the control command is then sent to (CD) player 134 for execution. In another embodiment, the dialog command is sent to VCP 310 via recognition software application 440, through wireless carrier system (140, 240). VCP 310 produces a control command, such as, for example by comparing the dialog command to the CD speech recognition grammar file. Once produced at VCP 310 within mobile vehicle (110, 210), the control command is then sent to (CD) player 134 for execution.

The above described embodiment allows for a majority of the processing to be completed by a server-side processor. In one embodiment, the above described embodiment allows the present invention to be utilized in pre-existing mobile vehicles that are not equipped with components to conduct the types of processing described above, but are equipped with telematics capabilities and interfaced with CD players.

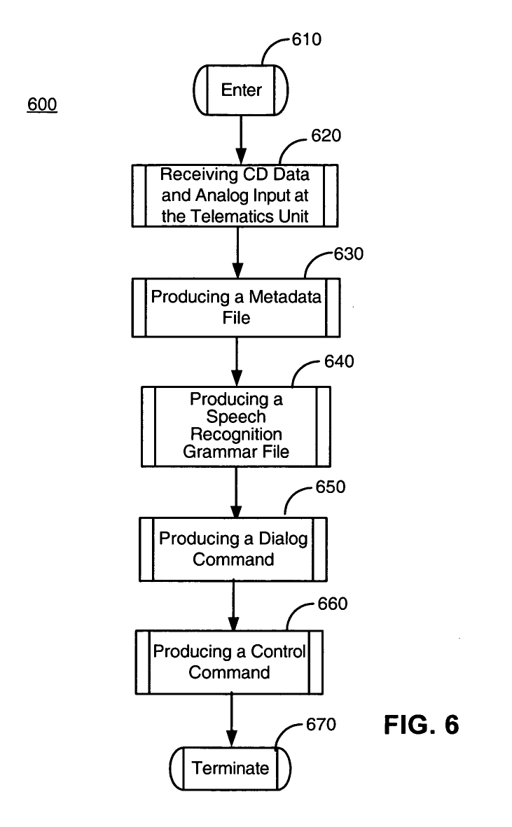

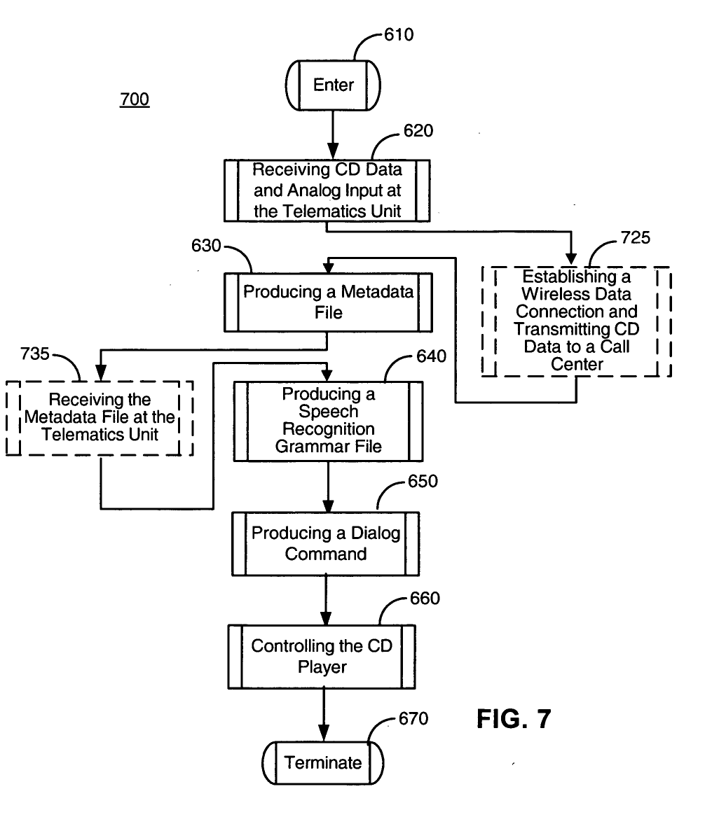

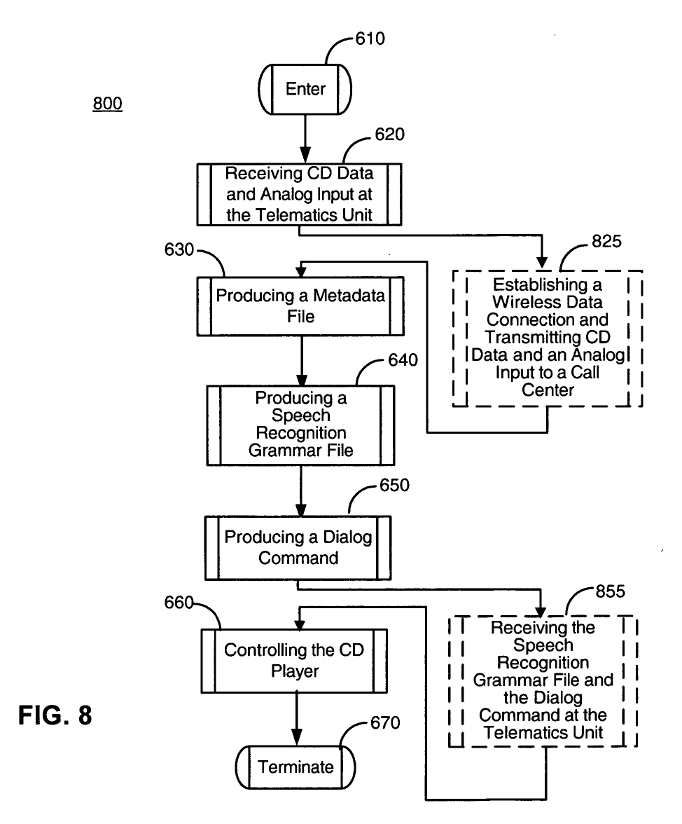

FIGS. 6-8 are flow diagrams of an embodiment of a method of controlling an in-vehicle CD player. In FIGS. 6-8, methods 600, 700, and 800 may utilize one or more systems detailed in FIGS. 1-5 above. The present invention can also take the form of a computer usable medium including a program for configuring an electronic module within a vehicle. The program stored in the computer usable medium comprises computer program code for executing the method steps described in FIG. 6-8. Blocks in FIGS. 7 and 8 that are numbered identically to blocks in FIG. 6 function in a substantially similar way.

In FIG. 6, method 600 begins at block 610. At block 620, CD data and analog input are received at the telematics unit. The CD data originating from at least one compact disc (CD) located within a portion of the CD player. In one embodiment, receiving the CD data at the telematics unit includes querying each of the compact discs for CD data and transferring the CD data to the telematics unit. In an example and referring to FIG. 1 above, receiving the CD data at the telematics unit 120 includes querying each of the compact discs within CD player 134 for CD data and transferring the CD data to the DSP 122 portion of telematics unit 120. In another example and referring to FIGS. 1 and 3 above, CD data is requested from CD player 134 by VUI 350 running on DSP 122 and sent to CD recognition software 340 for processing upon reception.

At block 630, a metadata file based on the received CD data is produced. In an example, metadata within the metadata file includes one or more members of the following: disc title, artist name, song title, disc number, and track number. In one embodiment, producing the metadata file based on the received CD data includes analyzing the CD data with music recognition software, identifying metadata within the CD data, and generating the metadata file. In an example and referring to FIG. 3 above, CD recognition software 340 receives the CD data from VUI 350 and utilizes commercially available music recognition software.

At block 640, a speech recognition grammar file is produced based on the metadata file. In one embodiment, producing the speech recognition grammar file based on the metadata file includes analyzing the metadata file with speech recognition software, identifying speech recognition grammar within the metadata, and generating the speech recognition grammar file. In another embodiment, producing the speech recognition grammar file based on the metadata file additionally includes transferring the generated speech recognition grammar file to an ASR engine having a dynamic grammar control mechanism.

In an example and referring to FIG. 3 above, the metadata file is then sent to vehicle communication platform (VCP) 310 for processing into a CD speech recognition grammar file. In this example, VCP 310 produces a CD speech recognition grammar file that is compatible with ASR software 330 by analyzing the metadata file with speech recognition software, identifying speech recognition grammar within the metadata, and generating the speech recognition grammar file.

At block 650, a dialog command is produced based on the received analog input. In one embodiment, ASR software receives the analog input and produces the dialog command utilizing commercially available software. In an example and referring to FIG. 3 above, ASR software 330 receives the analog input from VUI 350 and requests grammar files from ASR grammars database 360. ASR software 330 compares the received analog input to the grammar files received from ASR grammars database 360 to determine whether the received analog input matches grammar files stored within ASR grammars database 360. In this example, ASR software 330 produces the dialog command based on the comparison.

At block 660, the compact disc player in the telematics equipped mobile vehicle is controlled responsive to a control command that is based on the speech recognition grammar file and the dialog command. In one embodiment, controlling the compact disc player includes comparing the dialog command with the speech recognition grammar file, determining a control command based on the comparison, and implementing the control command. In an example and referring to FIGS. 1 and 3 above, the dialog command and the speech recognition grammar file are sent to VCP 310 for processing. In this example, VCP 310 produces a control command by comparing the dialog command to the CD speech recognition grammar file. The control command is then sent to CD player 134 for implementation.

At block 670, the method ends.

In FIG. 7, method 700 includes optional blocks 725 and 735 in addition to blocks 610-670 described in FIG. 6 above for implementing another embodiment of the present invention. At block 725, a wireless data connection between the telematics equipped mobile vehicle and a call center is established and CD data is sent to a call center.

In one embodiment, CD data is sent to CD recognition software, at the call center, via a wireless module, in the vehicle, and recognition software application, at the call center, for processing. In an example and referring to FIGS. 1, 2, and 4 above, the CD data is sent from VUI 350, via wireless phone module 480, through wireless carrier system (140, 240). VUI 350 and wireless phone module 480 operate on DSP 122 of telematics unit 120 that is located within mobile vehicle (110, 210). The CD data is received at call center (170, 270) for processing by CD recognition software 445.

At block 735, the metadata file is received at the telematics equipped mobile vehicle. In one embodiment, upon completion of the processing of the CD data, the metadata file is sent to the wireless module, in the mobile vehicle, via the recognition software application, at the call center, through a wireless carrier system. In an example and referring to FIGS. 1, 2, and 4 above, upon completion of the processing of the CD data, the metadata file is sent to VUI 350, via recognition software application 440, through wireless carrier system (140, 240).

In FIG. 8, method 800 includes optional blocks 825 and 855 in addition to blocks 610-670 described in FIG. 6 above for implementing another embodiment of the present invention. At block 825, a wireless data connection between the telematics equipped mobile vehicle and a call center is established, and CD data and an analog input is sent to a call center.

In one embodiment, CD data is sent to CD recognition software, at the call center, via a wireless module, in the vehicle, and recognition software application, at the call center, for processing. In an example and referring to FIGS. 1, 2, and 5 above, the CD data is sent from VUI 350, via wireless phone module 480, through wireless carrier system (140, 240). VUI 350 and wireless phone module 480 operate on DSP 122 of telematics unit 120 that is located within mobile vehicle (110, 210). The CD data is received at call center (170, 270) for processing by CD recognition software 445 and ASR module 530.

At block 855, the speech recognition grammar file and the dialog command are received at the telematics equipped mobile vehicle. In one embodiment, upon completion of the processing of the CD data and the analog input, the speech recognition grammar file and the dialog command are sent to the wireless module, in the mobile vehicle, via the recognition software application, at the call center, through a wireless carrier system. In an example and referring to FIGS. 1, 2, and 5 above, upon completion of the processing of the CD data and the analog input, the speech recognition grammar file and the dialog command are sent to VUI 350, via recognition software application 440, through wireless carrier system (140, 240).

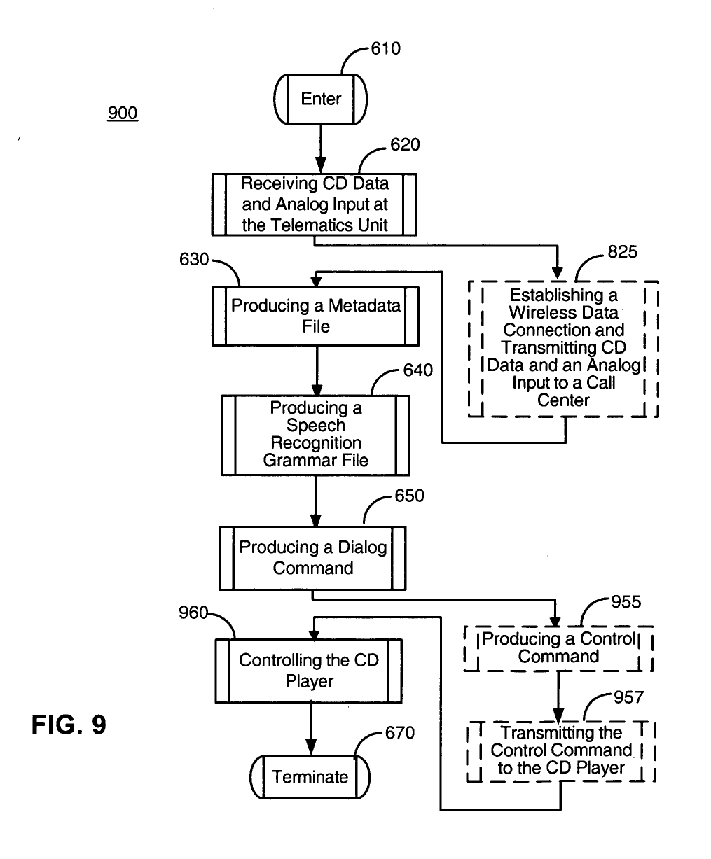

In FIG. 9, method 900 includes optional blocks 955 and 957, as well as block 960, and in addition to blocks 610-670 described in FIG. 6 above for implementing yet another embodiment of the present invention. At block 955, the control command is produced at the call center based on the speech recognition grammar file and the dialog command.

In one embodiment, the call center produces the control command, such as, for example by comparing the dialog command to the CD speech recognition grammar file and determining the control command based on the comparison. In an example and referring to FIGS. 1, 2, and 5 above, data center 410 produces a control command, such as, for example by comparing the dialog command to the CD speech recognition grammar file.

At block 957, the control command is received at the telematics equipped mobile vehicle. In one embodiment, the control command is sent to the mobile vehicle via the recognition software application, through the wireless carrier system. In an example and referring to FIGS. 1, 2, and 5 above, the control command is sent to VCP 310 via recognition software application 440, through wireless carrier system (140, 240).

At block 960, the compact disc player in the telematics equipped mobile vehicle is controlled responsive to the received control command. In one embodiment, once the control command is received at the mobile vehicle, the control command is sent to the CD player for execution. In an example and referring to FIGS. 1, 2, and 5 above, once received at VCP 310 within mobile vehicle (110, 210), the control command is then sent to (CD) player 134 for execution.

The above-described methods and implementation for controlling a compact disc player in a telematics equipped mobile vehicle are example methods and implementations. These methods and implementations illustrate one possible approach for controlling a compact disc player in a telematics equipped mobile vehicle. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its spirit or essential characteristics. The described embodiments are to be considered in all respects only as illustrative and not restrictive.

1. A method for controlling a compact disc player in a telematics equipped mobile vehicle, the method comprising:
receiving CD data and analog input at the telematics unit, the CD data received from at least one compact disc;
producing a metadata file based on the received CD data;
producing a speech recognition grammar file based on the metadata file;
producing a dialog command based on the received analog input; and
controlling the compact disc player in the telematics equipped mobile vehicle responsive to a control command, the control command based on the speech recognition grammar file and the dialog command.

2. The method of claim 1, wherein receiving CD data at the telematics unit comprises:
querying each of the compact discs for CD data; and
transferring the CD data to the telematics unit.

3. The method of claim 1, wherein the metadata is selected from one or more members of the group consisting of: disc title, artist name, song title, disc number, and track number.

4. The method of claim 1, wherein producing the metadata file based on the received CD data comprises:
analyzing the CD data with music recognition software;
identifying metadata within the CD data; and
generating the metadata file.

5. The method of claim 1, wherein producing the speech recognition grammar file based on the metadata file comprises:
analyzing the metadata file with speech recognition software;
identifying speech recognition grammar within the metadata; and
generating the speech recognition grammar file.

6. The method of claim 5, further comprising:
transferring the generated speech recognition grammar file to an ASR engine having a dynamic grammar control mechanism.

7. The method of claim 1, wherein controlling the compact disc player comprises:
comparing the dialog command with the speech recognition grammar file;
determining a control command based on the comparison; and
implementing the control command.

8. The method of claim 1, further comprising:
establishing a wireless data connection between the telematics equipped mobile vehicle and a call center;
sending the CD data to a call center; and
receiving the metadata file at the telematics equipped mobile vehicle.

9. The method of claim 1, further comprising:
establishing a wireless data connection between the telematics equipped mobile vehicle and a call center;
sending the CD data to a call center;
sending the analog input to the call center; and
receiving the speech recognition grammar file and the dialog command at the telematics equipped mobile vehicle.

10. The method of claim 1, further comprising:
establishing a wireless data connection between the telematics equipped mobile vehicle and a call center;
sending the CD data to a call center;
sending the analog input to the call center;
producing the control command at the call center; and
receiving the control command at the telematics equipped mobile vehicle.

11. The method of claim 10, wherein producing the control command comprises:
comparing the dialog command with the speech recognition grammar file at the call center; and
determining the control command based on the comparison at the call center.

12. A computer readable medium for controlling a compact disc player in a telematics equipped mobile vehicle, comprising:
computer readable code for receiving CD data and analog input at the telematics unit, the CD data received from at least one compact disc;
computer readable code for producing a metadata file based on the received CD data;
computer readable code for producing a speech recognition grammar file based on the metadata file;
computer readable code for producing a dialog command based on received analog input; and
computer readable code for controlling the compact disc player in the telematics equipped mobile vehicle responsive to a control command, the control command based on the speech recognition grammar file and the dialog command.

13. The computer readable medium of claim 12, wherein the computer readable code for receiving CD data at the telematics unit comprises:
computer readable code for querying each of the compact discs for CD data; and
computer readable code for transferring the CD data to the telematics unit.

14. The computer readable medium of claim 12, wherein the metadata is selected from one or more members of the group consisting of: disc title, artist name, song title, disc number, and track number.

15. The computer readable medium of claim 12, wherein the computer readable code for producing the metadata file based on the CD data comprises:
computer readable code for analyzing the CD data with music recognition software;
computer readable code for identifying metadata within the CD data; and
computer readable code for generating the metadata file.

16. The computer readable medium of claim 12, wherein the computer readable code for producing the speech recognition grammar file based on the metadata file comprises:
computer readable code for analyzing the metadata file with speech recognition software;
computer readable code for identifying speech recognition grammar within the metadata; and
computer readable code for generating the speech recognition grammar file.

17. The computer readable medium of claim 16, further comprising:
computer readable code for transferring the generated speech recognition grammar file to an ASR engine having a dynamic grammar control mechanism.

18. The computer readable medium of claim 12, wherein the computer readable code for controlling the compact disc player comprises:
computer readable code for comparing the dialog command with the speech recognition grammar file;
computer readable code for determining a control command based on the comparison; and
computer readable code for implementing the control command.

19. The computer readable medium of claim 12, further comprising:
computer readable code for establishing a wireless data connection between the telematics equipped mobile vehicle and a call center;
computer readable code for sending the CD data to a call center; and
computer readable code for receiving metadata file at the telematics equipped mobile vehicle.

20. The computer readable medium of claim 12, further comprising:
computer readable code for establishing a wireless data connection between the telematics equipped mobile vehicle and a call center;
computer readable code for sending the CD data to a call center;
computer readable code for sending the dialog command to the call center; and
computer readable code for receiving the speech recognition grammar file and the dialog command at the telematics equipped mobile vehicle.

21. The computer readable medium of claim 12, further comprising:
computer readable code for establishing a wireless data connection between the telematics equipped mobile vehicle and a call center;
computer readable code for sending the CD data to a call center;
computer readable code for sending the analog input to the call center;
computer readable code for producing the control command at the call center; and
computer readable code for receiving the control command at the telematics equipped mobile vehicle.

22. The computer readable medium of claim 21, wherein the computer readable code for producing the control command comprises:
computer readable code for comparing the dialog command with the speech recognition grammar file at the call center; and
computer readable code for determining the control command based on the comparison at the call center.

23. A system for controlling a compact disc player in a telematics equipped mobile vehicle, the system comprising:
means for receiving CD data at the telematics unit from at least one compact disc;
means for producing a metadata file based on the received CD data;
means for producing a speech recognition grammar file based on the metadata file;
means for receiving a dialog command; and
means for controlling the compact disc player in the telematics equipped mobile vehicle based on the dialog command.
